(19) United States
(12) Patent Application Publication
(10) Pub. No.: US 2005/0001978 A1
(43) Pub. Date: Jan. 6, 2005

(54) Colored contact lenses that enhance cosmetic appearance of light-eyed people

(76) Inventor: Gerardo J. Ocampo, Bridgeview, IL (US)

Correspondence Address: CIBA VISION CORPORATION;PATENT DEPARTMENT, 11460 JOHNS CREEK PARKWAY, DULUTH, GA, 30097-1556, US

(21) Appl. No.: 10/881,555

(22) Filed: Jun. 30, 2004

Related U.S. Application Data
(60) Provisional application No. 60/483,994, filed on Jul. 1, 2003.

(51) Int. Cl. G02C 7/04

(52) U.S. Cl. 351/162

(57) ABSTRACT

A colored contact lens comprising a clear pupil section and a colored, non-opaque iris section surrounding the pupil section. An intermittent pattern is deposited over the iris section using opaque elements which are indiscernible to the ordinary viewer and the inner border of the opaque section is uneven and non-circular. The elements of the pattern are of a shade which provides a contact lens capable of making subtle changes or enhancements to the color of the iris of a light-eyed person while imparting a very natural appearance.

This application claims the benefit under 35 USC § 119 (e) of U.S. provisional application No. 60/483,994 filed Jul. 1, 2003, incorporated by reference in its entirety.

### TECHNICAL FIELD

The present invention relates to colored contact lenses, and in particular to color contact lenses having colored portions corresponding to the iris portion of the human eye such that when the lenses are placed on the eye of a light-eyed person, the lenses are capable of making subtle changes to the color of the human eye and thereby enhancing the color of the eyes of the light-eyed person while maintaining a natural appearance.

### BACKGROUND OF THE INVENTION

Over the years many attempts have been made to modify or enhance the color of one's eyes using colored contact lenses with varying degrees of success. Attempts to produce an opaque lens with a natural appearance are disclosed in U.S. Pat. No. 3,536,386 to Spivak; U.S. Pat. No. 3,679,504 to Wichterle; U.S. Pat. No. 3,712,718 to LeGrand, U.S. Pat. No. 4,460,523 to Neefe, U.S. Pat. No. 4,719,657 to Bawa, U.S. Pat. No. 4,744,647 to Meshel, et al., U.S. Pat. No. 4,634,449 to Jenkins; EP Publication No. 0 309 154 (Allergan); and U.K. Patent Application No. 2 202 540 A (IGEL).

Commercial success was achieved by the colored contact lens described in U.S. Pat. No. 4,582,402 to Knapp, which discloses a contact lens having, in its preferred embodiment, colored, opaque dots. The Knapp lens provides a natural appearance with a lens that is simple and inexpensive to produce, using a simple one-color printed dot pattern. Although, in Knapp, the intermittent pattern of dots does not fully cover the iris, the invention provides a sufficient density of dots that a masking effect gives the appearance of a continuous color when viewed by an ordinary observer. Knapp also discloses that the printing step may be repeated one or more-times using different patterns in different colors, since upon close examination the iris's of many persons are found to contain more than one color. The printed pattern need not be absolutely uniform, allowing for enhancement of the fine structure of the iris. The one-color Knapp lenses had their dots arranged in an irregular pattern to enhance the structure of the iris. However, neither the Knapp lenses, nor the Knapp patent disclose or suggest a contact lens designed for the person having light-colored eyes in which the colored contact lens provides a subtle change or enhancement to the eyes of a light-eyed person.

Various efforts have been made to improve on the Knapp lens. For example, U.S. Pat. No. 5,414,477 to Jahnke discloses the application of the intermittent ink pattern in two or more portions of distinct shades of colorant to provide a more natural appearance. Such lenses have achieved commercial success based, at least partially, upon their strikingly natural appearance. However, such lenses are more suitable for a change in eye color, as opposed to a subtle enhancement of the wearer's natural color.

Other attempts to create a more natural appearing lens include U.S. Pat. No. 5,120,121 to Rawlings which discloses a cluster of interconnecting lines radiating from the periphery of the pupil portion to the periphery of the iris portion. Further, European Patent No. 0 472 496 A2 shows a contact lens having a pattern of lines that attempts to replicate the lines found in the iris. Once again, these lenses are more suitable for a change in eye color, as opposed to a subtle enhancement of the wearer's natural color.

Attempts to subtly enhance the color of a light-colored eyes without changing the color thereof have been somewhat successful. U.S. Pat. No. 4,634,449 to Jenkins and U.S. Pat. No. 4,954,132 to Hung, et al. disclose transparent reactive dyes covering the entire iris region to enhance the color thereof. U.S. Pat. No. 5,793,466 to Moncada discloses a plurality of colored lines radiating out from a circle cicumscribing the pupil. While such lenses do enhance the eye color of the wearer, they do not achieve the strikingly natural appearance desired in the industry.

Accordingly, the contact lens industry continues to seek a low-cost, colored lens that can enhance the color of a light-colored iris while providing its inherent depth and texture. This objective has been more closely achieved by providing colored contact lenses that allow some of the natural iris color and pattern surrounding the pupil to show through the lens and become part of the overall visual impact of the eye-lens combination.

### SUMMARY OF THE INVENTION

The present invention is based on the surprising discovery that certain transparent and opaque patterns on colored contact lenses can achieve a subtle enhancement to the appearance of the iris for people having light-colored irises, or light-eyed people. The improvement in appearance for light-eyed people over existing lenses is startling. Unlike previous lenses, the lenses of this invention are able to cause subtle change or enhancement to the color of the light-eyed wearer's iris, i.e., a blue- or green-eyed person, by not obscuring the portion of the natural iris immediately surrounding the pupil. Thus, the transparent pupil area is much larger and the colored iris area begins at a further distance from the pupil than in prior lenses. Although in the preferred embodiment of the invention the iris area is a randomized pattern, other patterns are contemplated.

One objective of the invention is to provide a colored contact lens with a non-opaque pupil section, an iris section surrounding said pupil section, where the iris section is separated from the pupil area by a jagged border. A colored, non-opaque pattern covers the iris section. The pattern is a randomized pattern, the elements of which are non-opaque and indiscernible to the ordinary viewer. The pattern is intermittent with small, un-colored spaces in the interstitial areas amongst the colored portions of the pattern. The elements of the pattern are of a shade, such as aqua, green, blue, or violet which provides a lens capable of making subtle changes or enhancements to the color of the iris of a light-eyed person wearing the lens while imparting a very natural appearance. The lens can optionally include a second pattern printed upon or around the iris area closer to the edge of the contact lens.

Another objective of the invention is to provide a colored contact lens comprising a non-opaque pupil section, an iris section surrounding said pupil section, with a jagged border separating the pupil section from the iris section. The iris pattern is a colored, non-opaque intermittent pattern over the iris section that leaves a portion of the pattern unprinted, said pattern covering at least about 15 percent of the area of said iris section. The pattern is made up of non-opaque elements of colorant, in a random pixelated pattern, thereby providing a lens capable of making a subtle change and enhancing the color of the iris of a person having light colored eyes while imparting a very natural appearance.

Another objective of the invention is to provide a colored contact lens with a non-opaque pupil section, an iris section surrounding the pupil section, and a colored, opaque intermittent pattern surrounding the iris section, that leaves a substantial portion within the interstices of the pattern non-opaque. The elements of the pattern are opaque and indiscernible to the ordinary viewer. The pupil section is located generally at the center of the lens over the pupil and extending into the area of the inner portion of the iris adjacent to the pupil of the eye and has an uneven border at its outer end. The uneven border is a minimum distance of about 5% to about 60% of the radial width of said iris section, and the maximum distance of the uneven border from the outer perimeter of said iris section is from about 25% to about 90% of the radial width of said iris section, thereby providing a lens capable of making subtle changes or enhancements to the color of the iris of a light-eyed person wearing the lens while imparting a very natural appearance.

Another objective of the invention is to provide printing methods for manufacturing the above-described and similar contact lenses.

The term “non-opaque” as used herein is intended to describe a part of the lens that is uncolored or colored with translucent coloring.

The term “ordinary viewer” is intended to mean a person having normal 20-20 vision standing about 5 feet from a person wearing the lenses of this invention.

### BRIEF DESCRIPTION OF THE DRAWINGS

FIG. 1 illustrates a contact lens pattern in accordance with the present invention;

FIG. 2 illustrates a contact lens pattern in accordance with an alternative embodiment of the present invention;

FIG. 3 illustrates a contact lens pattern in accordance with an alternative embodiment of the present invention;

FIG. 4 illustrates a contact lens pattern in accordance with an alternative embodiment of the present invention.

FIG. 5 illustrates a contact lens pattern in accordance with an alternative embodiment of the present invention.

### DETAILED DESCRIPTION OF THE PREFERRED EMBODIMENTS

In the context of this invention, although some terms are referred to in the singular, it is understood that such references may also encompass the plural. For example, although color is referred to in the singular, it is understood that some colors comprise different color components.

Further, it is understood that the term “eye color” refers to the color of the iris. Moreover, the percentages in the formulations are based on weight percentages unless otherwise specified. However, for the population of color elements within a region, percent refers to the portion of the total area within the region covered by the color elements as measured by an image analyzer known in the art such as a BAUSCH & LOMB OMNICON 5000™ calibrated against a known standard. Finally, all references cited herein are incorporated by reference.

This invention uses a pattern of color elements with a contact lens to enhance or modify the natural color of the wearer's eye. At the same time, the pattern also provides a more natural appearance by adding texture and depth to the iris as perceived by the ordinary viewer.

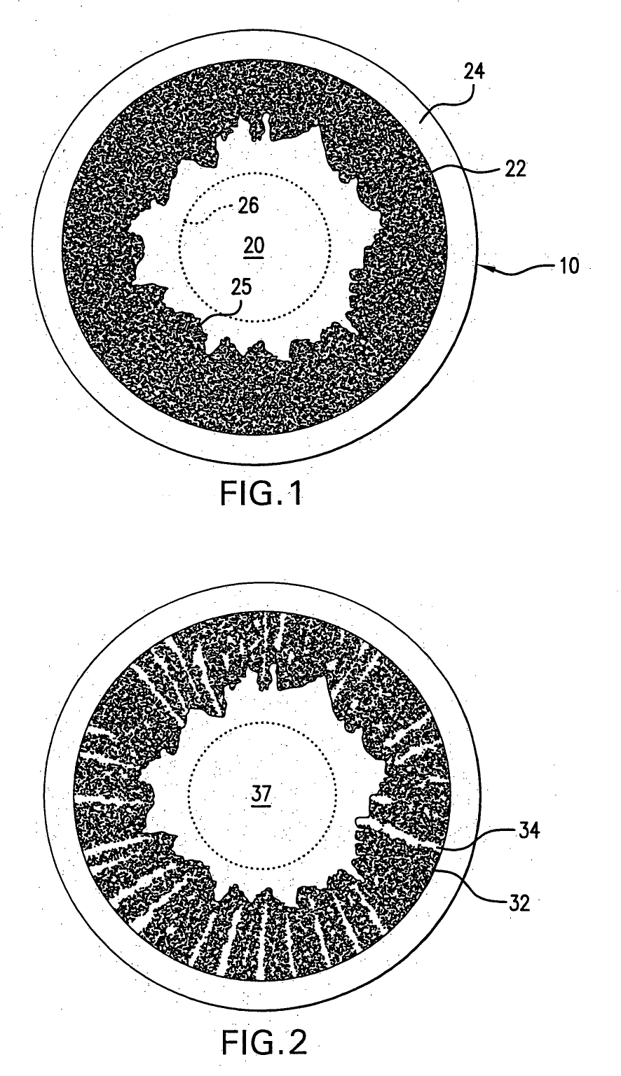

FIG. 1 shows a contact lens 10 according to one embodiment of the invention. The contact lens contains a clear pupil area 20 which corresponds to the pupil section of the human eye 26 such that when the contact lens is placed on the eye, the pupil section 20 of the contact lens will come in contact with the pupil 26 of the eye. However, in contrast to prior lenses, the pupil area of the present lens is larger than the pupil of the eye 26. The clear pupil area 20 is separated from the colored iris section 22 by a jagged or irregular border 25. When placed on the eye, the iris section 22 will cover only a portion of the natural iris and will not cover that portion of the natural iris 20 that lies immediately outside the pupil 26. The iris section of the contact lens 22 is not opaque, but rather is colored only to the extent that it will influence the perceived color of the underlying iris, but will still allow the structure and fine detail of the natural iris to been seen therethough. A clear peripheral section 24 surrounds iris section 22 and is typically left uncolored because it will lay over the sclera when placed on the eye.

Thus, different portions of the natural iris will be perceived as being of different colors by an ordinary viewer. Specifically, when placed on the eye, the inner portions of the natural iris will not be covered by the iris section 22 and thus will be perceived by an ordinary viewer as the natural color of the iris. The outer portion of the natural iris, however, will be covered by the non-opaque colored iris section 22 and will be perceived as being a darker color than the inner portions of the natural iris, which are visible through the clear pupil section 20. Thus, the visual perception of the eye will be greatly enhanced. Because the natural iris appears to be randomly structured (or at least not highly ordered in structure), it is preferably that the jagged border 25 separating the clear pupil area from the colored iris section 22 be irregularly shaped and appearing to have no ordered pattern. However, one of skill in the will recognize that the primary consideration is that the border appear natural and that some ordered border patterns can provide a natural appearance. Nonetheless, a perfectly circular border between the clear pupil area 20 and the colored iris section 22 provides a rather unnatural appearance and is not part of this invention.

While the iris section 22 of FIG. 1, was a solid non-opaque colored area, other patterns are within the scope of this invention. As shown in FIG. 2, the iris section can comprise an intermittent pattern that leaves a portion of the iris section 32 within the interstices of the pattern clear or less densely colored. The clear areas 34 of the iris section 32 appear white in FIG. 2, and appear clear on the actual contact lens. Furthermore, the colored iris section 32 can either be solid or be composed of a pattern of closely spaced dots. Certain portions of the colored iris section 32 may be more of less densely covered with dots than other portions. This arrangement may enhance the structure of the iris of a person wearing the lens. Of course, the colored pattern may be comprised of dots having any shape, regular or irregular, such as round, square, hexagonal, elongated, etc. Further, the elements of the pattern may have a shape other than dots, so long as the elements are indiscernible to the ordinary viewer, cover at least about 15 percent of the iris, and leave a portion of the natural iris showing though the pupil section 37.

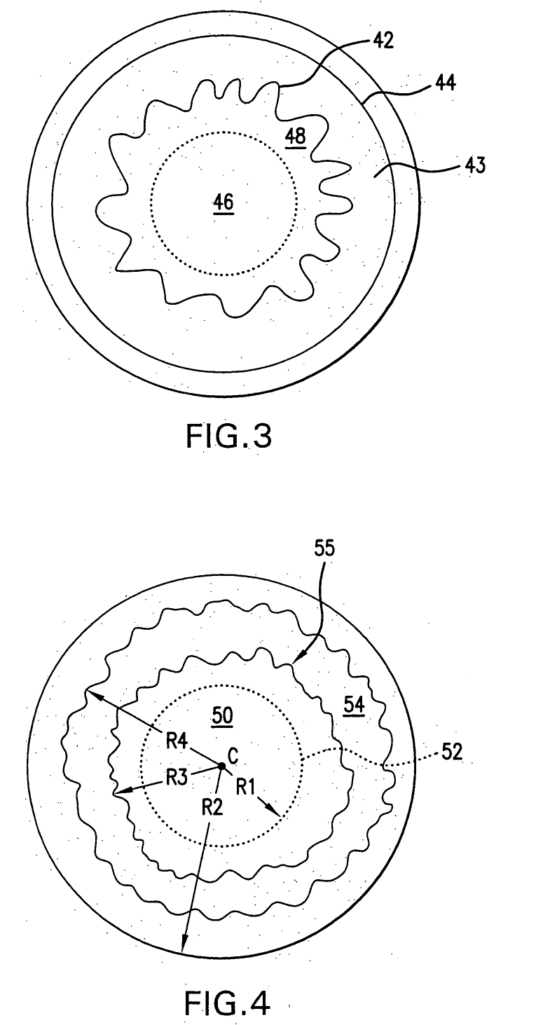

The improvement of this invention is a simple single or multiple-color pattern that greatly enhances the color of a light-colored iris, even over those lenses now achieving much commercial success. As shown in FIG. 3, another embodiment of the present invention comprises a lens having at least two colored portions. The iris portion 43 covers a portion of the natural iris, but leaves the area 48 immediately surrounding the natural pupil 46 non-opaque. A second colored portion, referred to as the limbal ring 44, surround the iris section 43. The border between the limbal ring 44 and the iris portion 43 may be regular, or irregular, and may overlap to some degree.

It is preferable that the limbal ring 44 be a different shade than the iris section 43, more preferably a darker shade. By different shade, it is intended to mean that both shades are of totally different colors, such as blue and hazel; or that both shades are of the same basic color, but having different intensities, such as light blue and dark blue. While the limbal ring 44 can be black or gray, it is preferred that the limbal ring 44 be a darker shade of the color of the iris portion 43. For example, if the iris portion 43 is green or light green, it is preferred that the limbal ring 44 be dark green.

Producing the colored portions of the iris section 43 and limbal ring 44 is preferably accomplished by printing the lens twice using the known printing processes described below.

Yet another embodiment of the present invention is shown in FIG. 4. The contact lens (not shown) contains a clear pupil area 50 which corresponds to the pupil section of the human eye 52 such that when the contact lens is placed on the eye, the pupil section 50 of the contact lens will come in contact with the pupil 52 of the eye. The clear pupil area 50 is separated from the colored iris section 53 by a jagged or irregular border 55. When placed on the eye, the iris section 50 will cover only a portion of the natural iris and will not cover that portion of the natural iris that lies immediately outside the pupil 52. While the radius of a typical human pupil R¹ can range from 1 mm in bright light conditions, a typically encountered pupil radius in normal conditions is about 2.2-2.5 mm. Thus the inner jagged border 55 of the iris section 54 should be further than 2.5 mm from the center of the lens C. Preferably, it is at least 2.9 mm from the center of the lens C, more preferably, at least 3 mm from the center of the lens.

Because the inner jagged border 55 of the iris section 54 is non-circular, it is not possible to definitively define a “radius” in the normal use of that term. However, the inner jagged border 55 can be measured from the center of the lens C and generally defined as having a minimum “radius,” a maximum “radius,” and an average “radius.” The minimum radius is defined as that point in which the iris section is at its closest to the center C; and the maximum radius is defined as that point at which the iris section is at its farthest from the center C. The average radius of the jagged border is the mean of the distances of the jagged border 55 from the center of the lens C.

The minimum radius R³ of the jagged border 55 is preferably between 2.5 mm and 3.5 mm; preferably between 2.9 mm and 3.5 mm; more preferably greater than 3 mm. The maximum radius R³ of the jagged border 55 is greater than 2.6 mm, more preferably greater than 3 mm. The maximum radius can also be greater than 3.5 mm. The average radius R³ of the jagged border 55 is greater than 2.5, for example, between 2.5 mm and 3.5 mm; preferably between 2.5 mm and 3.2 mm; more preferably between 2.6 mm and 3.1; most preferably between 2.6 mm and 3.0 mm. The jagged border can be characterized by peaks and valleys, with as little as 0.1 mm, or less, or as much as 1 mm, or more, differences in radii between adjacent peaks and valleys. Thus, the differences in maximum radius and minimum radius can be from 0.1 mm or greater, preferably greater than 0.2 mm; more preferably greater than 0.3 mm; most preferably greater than 0.4 mm. The difference between the maximum and minimum can also be greater than 0.5 mm, or greater than 0.6 mm.

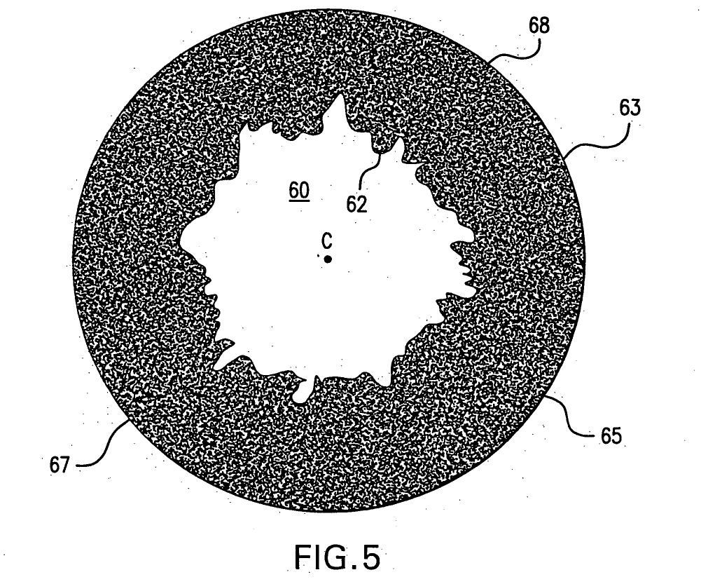

The pattern depicted in FIG. 5 is yet another embodiment of the present invention. Colored iris pattern 63 surrounds a non-opaque pupil section 60. The pattern 63 has a even circular outer border 65 and an uneven jagged inner border 62. The pattern has randomly distributed opaque elements 67 interspersed with non-opaque areas 68. Because the jagged border 62 is more than 2.5 mm away from the center of the lens C at all points, a substantial portion of the wearers natural iris (not shown) is visible through the non-opaque pupil section 60, thus providing a natural starburst effect.

The improvement of this invention is the use patterns and coverage of the iris section of the contact lens that provides subtle changes or enhancements to the appearance of the iris of a person having light colored eyes, such as light blue, while providing a natural appearance. To produce this color pattern according to the preferred embodiment, particularly colored dots (or some other element) are printed on the iris section of the contact lens in a pattern that covers the iris section while leaving certain areas, particularly the area immediately surrounding the natural pupil, of the iris section non-opaque.

Although many colors may be utilized to enhance the appearance of the iris, the particular colors used to create the subtle changes or enhancements to the eye of a light-eyed person include green, blue, aqua, violet, yellow, and shades thereof.

Formulations of the most preferred ink pastes are:

| Ingredient | Outer | Green | Blue | Aqua | Violet |
|---|---|---|---|---|---|
| Ethyl Lactate | 23.98% | 31.35% | 22.50% | 22.50% | 22.50% |
| Polymer | 64.04% | 65.33% | 76.00% | 76.01% | 76.00% |
| Soln. | | | | | |
| PCN Blue | —% | —% | 1.50% | 0.29% | —% |
| PCN Green | —% | 0.90% | —% | 1.20% | —% |
| Carbazole | —% | —% | —% | —% | 1.50% |
| Violet | | | | | |
| Iron Oxide | —% | 2.42 | —% | —% | —% |
| Yellow | | | | | |
| Iron Oxide | 11.98% | —% | —% | —% | —% |
| Black | | | | | |
| Total | 100.00% | 100.00% | 100.00% | 100.00% | 100.00% |

To produce the preferred ink paste, the ingredients are mixed in a grinding media. For 651 gram and 3000 gram samples of ink paste, 850 grams and 4298 grams of grinding media are used, respectively. The target viscosity of the polymer solutions are about 35,000 CPS for each formulation, except for the green color which has a target viscosity of about 50,000 CPS.

This pattern can be applied to a variety of contact lenses, on the anterior (away from eye) or posterior (in contact with eye) surface, or formulated within the contact lens. In a preferred lens the pattern is applied to the anterior surface. On a hard contact lens, the outer periphery of the pattern lies at substantially the edge of the contact lens. On a soft contact lens, the outer periphery of the pattern may be surrounded by a non-opaque sclera section. The preferred contact lenses are disclosed in U.S. Pat. Nos. 4,405,773 and 4,668,240 both to Loshaek. The preferred lenses used with the inventive pattern are substantially clear and colorless. However, lenses that have a slight tint are embraced within the invention, provided the tint does not substantially alter the appearance imparted by the color elements when viewed by the ordinary observer.

Producing the opaque portions of the iris section is preferably accomplished by printing the lens using the known printing process of U.S. Pat. No. 4,582,402 to Knapp, incorporated herein by reference, and the known printing process of U.S. Pat. Nos. 5,034,166 and 5,116,112 to Rawlings, incorporated herein by reference. Generally, a plate or cliche having depressions in the desired pattern is smeared with ink of the desired shade. Excess ink is removed by scrapping the surface of the plate with a doctor blade leaving the depression filled with ink. A silicon rubber pad is pressed against the plate to pick up the ink from the depressions and then is pressed against a surface of the lens to transfer the pattern to the lens. The printed pattern is then cured to render it unremovable from the lens. Of course, either the anterior or posterior surfaces of the lens may be printed, but printing the anterior surface is presently preferred.

The preferred lenses used to practice this invention are known and described in U.S. Pat. No. 4,668,240 to Loshaek, incorporated herein by reference. Very briefly, a lens constructured of polymer having —COOH, —OH, or —NH₂ groups is printed with ink containing binding polymer as described above. First a solution of binding polymer and solvent is prepared and this solution is mixed with paste containing the coloring substance to form an ink. The preferred binding polymer solutions described in the Loshaek patent have a viscosity of 25,000 cps. It is currently preferred to form inks for the present lenses from binding polymer solutions having a viscosity of about 40,000 cps. The opaque ink is printed and cured on the lens surface.

Of course, alternative ways to form colored opaque elements of the lens may be used. For example, selected portions of the iris section of a wetted hydrophilic lens may be impregnated with a solution of a first substance, such as barium chloride. Then the lens may be immersed in a solution of a second substance, such as sulfuric acid, that forms an opaque, water-insoluble precipitate with the first substance, for example barium sulfate. Thus, an opaque precipitate forms within the lens in a predetermined pattern in the iris section. Next all or at least the opaque pattern of the iris section is colored opaque pattern in accordance with the invention. If the entire iris is colored with translucent tint, then the interstices within the pattern will be translucently colored, but still non-opaque and in accordance with the present invention. Optionally, the pupil section of the lens may be colored by a non-opaque tint, because such tint is not visible when the lens is against the dark pupil present in the eye of the wearer. Other alternative opaquing methods include use of a laser (U.S. Pat. No. 4,744,647) and finely ground particles (U.S. Pat. No. 4,460,523).

The process of the present invention for making colored contact lenses is as follows. A transparent contact lens comprising at least a pupil section and an iris section surrounding the pupil section is provided.

If the lens is constructed of a hydrophilic material, it also has a peripheral section surrounding iris section. For hydrophilic material, the steps described below are performed with the material in an unhydrated state. Preferred hydrophilic materials are disclosed by Loshaek in U.S. Pat. No. 4,405,773, incorporated herein by reference.

The colored pattern may be deposited onto iris section of the lens in any manner. The currently preferred method is by offset pad printing, described below in some detail.

A plate (not shown) is prepared having flat surface and circular depressions corresponding to the desired dot pattern. To make the pattern shown in FIGS each depression should have a diameter with a range of about 0.05 to 0.15 mm, preferably 0.10 mm, and a depth preferably about 0.013 mm. The depressions are arranged to cover an annular shape corresponding to that of the iris section of the lens.

The plate may be made by a technique that is well known for making integrated analog or digital circuits. First a pattern about 20 times as large as the desired pattern is prepared. Next the pattern is reduced to the required size using well known photographic techniques to a pattern of the exact desired size having the portion to be colored darker than the remaining area. A flat metal surface is covered by a photo resist material which becomes water insoluble when exposed to light. The photo resist material is covered with the pattern and exposed to light. The unnecessary portion of the photo resist pattern is removed by washing with water and the metal plate is etched at the portions not exposed to light to the required depth. Then the remainder of the photoresist material is mechanically removed after the etching process.

Colorant, comprising a pigment and binder or carrier for the pigment is deposited on flat surface of the plate and scraped across the pattern with a doctor blade. This causes depressions to be filled with ink while removing excess ink from flat surface. The colorant may be more or less opaque depending on the degree of color change desired. The opacity may be varied by modifying the proportion of pigment to binder in the colorant. It will be recognized that a desired effect may be obtained using a highly opaque colorant or by having a somewhat less opaque colorant and covering a greater portion of the iris section surface.

A pad made of silicon rubber, impregnated with silicon oil for easy release, is pressed against the pattern, removing ink from depressions. The ink on the pad is allowed to dry slightly as needed to improve tackiness, then pressed against the front surface of the contact lens, depositing the ink in the desired pattern over the iris section. Of course the pad must have enough flexibility to deform to fit over the convex front surface of the lens. The printing could be done in the concave surface of the lens by modifying the shape of the pad and placement of the lens. For a more natural effect, the printing step may be repeated one or more times using different patterns in different colors, since upon close examination, the iris's of many persons are found to contain more than one color. The printed pattern need not be absolutely uniform, allowing for enhancement of the fine structure of the iris. A more natural appearance may be obtained by printing on both the concave and convex sides of the lens.

Next the deposited pattern is treated to render it resistant to removal from the lens under exposure to the ocular fluids that the lens will encounter when placed in the eye and when lens cleaning takes place. The exact method of preventing removal depends on the material of construction of the lens and the pattern. Mere air drying or heating the lens may suffice. For hydrophilic lenses, the techniques for coating the opaque pattern described in U.S. Pat. No. 3,679,504 to Wichterle (incorporated herein by reference) may be used.

The method for manufacturing a colored contact lens in accordance with the present invention generally includes the steps of applying colorant to the surface of a transparent contact lens and rendering the colorant resistant to removal from ocular fluids. The printed contact lens will have a non-opaque pupil section and an iris section surrounding said pupil section with the pattern of the present invention.

The steps used in order to deposit the intermittent pattern on the lens surface require a plate having depressions corresponding to the patterns described in detail above, and filling the depressions with colorant of the required shade. In the preferred embodiment the colorant or shade is either red, mahogany, light hazel or starburst hazel. Then, pressing a flexible pad against the plate and subsequently pressing the flexible pad against the surface of the lens (either side) thereby printing the patterns on the lens. In the case where two patterns are contemplated, two separate printings using the different patterns and different colors must be utilized.

It can be seen that the present invention provides lenses capable of providing a subtle change or enhancement to the iris of a light-eyed person while allowing visualization of the fine structure thereof and providing a natural appearance. Various changes may be made in the function and arrangement of parts: equivalent means may be substituted for those illustrated and described; and certain features may be used independently from others without departing from the spirit and scope of the invention as defined in the following claims.

1. A colored contact lens comprising a non-opaque pupil section, an iris section surrounding said pupil section, and a colored, opaque intermittent pattern over said entire iris section that leaves a substantial portion within the interstices of the pattern non-opaque, said pattern having an inner border and outer border and being made up of elements and covering at least about 15 percent of the area of said iris section, the elements of said pattern being opaque and indiscernible to the ordinary viewer, wherein said inner border is jagged.

2. A colored contact lens as claimed in claim 1, further comprising a second colored pattern of a shade different from the first located generally at and surrounding the outer border of said iris section.

3. A colored contact lens comprising a non-opaque pupil section, an iris section surrounding said pupil section, and a colored, opaque intermittent pattern over said entire iris section that leaves a substantial portion within the interstices of the pattern non-opaque, said pattern having an inner border and outer border and being made up of elements and covering at least about 15 percent of the area of said iris section, the elements of said pattern being opaque and indiscernible to the ordinary viewer, wherein said inner border is jagged and said non-opaque pupil section has an average width of greater than 2.6 mm.

4. A colored contact lens as claimed in claim 3, further comprising a second colored pattern of a shade different from the first located generally at and surrounding the outer border of said iris section.
